(19) United States
(12) Patent Application Publication
(10) Pub. No.: US 2022/0122165 A1
(43) Pub. Date: Apr. 21, 2022

(54) Mitigating Risk During Deployment of Military Customers

(71) Applicant: Wells Fargo Bank, N.A., San Francisco, CA (US)

(72) Inventors: Darius A. Miranda, San Francisco, CA (US); Wairnola M. Rhodriquez, San Francisco, CA (US); Laura Mead Marks, Mill Valley, CA (US); Gerald T. Quinn, Parker, CO (US); Chris Kalaboukis, San Jose, CA (US); Gregory K. Morishige, Berkeley, CA (US); Raymond Alan Schnitzler, Piedmont, CA (US); Paulina Ma, San Leandro, CA (US); Xu Stoica-Zhang, San Francisco Daly City, CA (US)

(21) Appl. No.: 16/015,915

(22) Filed: Jun. 22, 2018

(51) Int. Cl. G06Q 40/02; G06Q 50/18; G10L 17/04; G10L 17/06; G10L 17/22

(52) U.S. Cl. CPC G06Q 40/02; G06Q 50/18; G10L 17/22; G10L 17/06; G10L 17/04

(57) ABSTRACT

A method for mitigating financial risk of a financial institution for military personnel who are customers of the financial institution includes obtaining the deployment status of a person in the military, the person being a customer of the financial institution. The electronic computing device automatically determines when the deployment status has changed to a deployed status. When a determination is made that the deployment status has changed to the deployed status, one or more procedures are implemented to minimize the financial risk of the financial institution while the person is on deployment.

### BACKGROUND

Military personnel can be subject to overseas deployment at various times. Although the military personnel can be aware of an impending deployment, the actual occurrence of the deployment can be disruptive to the lives of the military personnel and their families.

Financial issues during deployment can be a problem for the military personnel and their families. Although legislation protects military personnel from certain financial aspects of deployment, not all financial issues are addressed.

### SUMMARY

Embodiments of the disclosure are directed to a method implemented on an electronic computing device for mitigating financial risk of a financial institution for military personnel who are customers of the financial institution, the method comprising: obtaining the deployment status of a person in the military, the person being a customer of the financial institution; automatically determining, by the electronic computing device, when the deployment status has changed to a deployed status; and when a determination is made that the deployment status has changed to the deployed status, implementing one or more procedures to minimize the financial risk of the financial institution while the person is on deployment.

In another aspect, a method implemented on an electronic computing device for providing services to military customers of a financial institution comprises: determining a deployment status of a military customer; and when a determination is made that the deployment status of the military customer is a pre-deployed status: automatically implementing one or more procedures or services for the military customer relating to pre-deployment; periodically monitoring the deployment status of the military customer; and when a determination is made that the military customer has transitioned to a deployed status, automatically implementing one or more procedures or services for the military customer relating to deployment.

In yet another aspect, an electronic computing device comprises: a processing unit; and system memory, the system memory including instructions which, when executed by the processing unit, cause the electronic computing device to: access a military database to determine a current military deployment status of a person; and when the current military deployment status of the person is a pre-deployment status: implement one or more procedures to minimize a financial risk of the person to a financial institution when the person is on deployment, the one or more procedures including providing one or more incentives to encourage the person to designate an individual as a power of attorney and to create an advanced directive, at least one of the incentives comprising a monetary reward; periodically access the military database to monitor the current military deployment status of the person; and when the current military deployment status indicates deployment: designate the current military deployment status of the person as deployed; and activate the advanced directive.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports mitigating risk during deployment of military customers.

FIG. 2 shows example modules of the risk assessment engine of FIG. 1.

FIG. 3 shows an example graphical user interface that can be used with the system of FIG. 1.

FIG. 4 shows a graphical user interface for pre-deployment information.

FIG. 5 shows a graphical user interface for deployment information.

FIG. 6 shows a graphical user interface for post-deployment information.

FIG. 7 shows an example method for implementing services for military customers based on deployment status.

FIG. 8 shows an example method for mitigating risk during deployment of military customers.

FIG. 9 shows example physical components of the organization server computing device of the system of FIG. 1.

### DETAILED DESCRIPTION

The present disclosure is directed to systems and methods for mitigating risk during deployment of military customers. Using the systems and methods, the financial institution can provide financial services that can help a military customer before they are deployed, during deployment and after they return from deployment. As discussed in more detail later herein, the financial services can include, without limitation, helping the military customer implement a power of attorney (POA), and an advanced directive that can specify how financial affairs of the military customer are to be handled during deployment. The financial institution can also help the military customer with other financial issues, for example handling mortgages and other bills during deployment.

The systems and methods can also provide for automatically determining when a status of a military customer changes, such as from pre-deployment to deployed. The financial institution can notify third party organizations that deal with the customer of the change in status. Although legislation can protect a military customer for certain financial aspects of deployment, financial institutions and other organizations that deal with the customer need to be aware that the military customer is actually deployed.

The Servicemembers Civil Relief Act (SCRA) protects military personnel from being sued while on active military duty and for a year after active duty. The protection extends to such items as foreclosures, garnishments, attachments, evictions, and judgments. Verification of an active duty status can be obtained via the Defense Manpower Data Center (DMDC), which maintains records of all active duty military personnel.

Using the systems and methods, the financial institution (for example, a bank) where the military customer has one or more financial accounts can use an application programming interface (API) of the DMDC to determine the deployment status of the military customer. In one implementation, the financial institution can access a database of the DMDC via the API. In some implementations, a website of the DMDC can be accessed. Once a determination is made that the status of the military customer has changed to a deployed status, the financial institution can implement certain procedures that can be used to help the military customer during deployment.

In addition to the DMDC, other methods can be used to detect possible changes in deployment status. Example methods can include indicators of location, including IP address (geoIP or military-assigned IP), device location data, time zone information, time-of-day activity changes, etc. These methods can initiate triggers to follow up with more authoritative data sources regarding deployment status. In addition, the methods can be used to detect when the military customer may be on leave within the United States, and hence available to address financial matters that may be awaiting their attention.

In addition, as a service to the military customer, the financial institution can notify third-party organizations having business with the military customer that have a need to know of the change to the deployed status. For example, when the financial institution has knowledge of a third-party organization that holds a mortgage for the military customer, the financial institution can notify the third-party organization of the status change to deployment.

As mentioned earlier herein, the financial institution can proactively work with the military customer before deployment to obtain a POA and an advanced directive for the military customer. The POA and the advanced directive permit a person chosen by the military customer to act on the behalf of the military customer during deployment. When authorized by the advanced directive, the person with the POA can pay bills for the military customer or make arrangements to have bills paid for the military customer, sign documents on behalf of the military customer, withdraw money from a financial account of the military customer and perform other financial activities for the military customer. The advanced directive can be configured to automatically activate when a change in deployment status from pre-deployed to deployed is detected.

The person with POA can also help the military customer with any authentication issues that may arise when the military customer is deployed overseas. For example, when the military customer is unable to access his/her bank account from overseas because of authentication issues caused by firewalls and other factors, the person with the POA can help to resolve these issues.

The advanced directive can also authorize a person other than the POA to handle financial tasks on behalf of the military person. This person, defined herein as an informed person, can be someone who may or may not have a POA, but who would be notified of bills or delinquencies or other events/issues.

The financial institution can also offer a bill review service to military customers. The bill review service can evaluate checks, bill pay payments, and other online debits and attempt to automate bill payment. For example, the bill review service can help the military customers set up automatic payments, configure electronic bills (eBills), where available, and work with merchants, particularly merchants with significant military clientele to add eBill support.

The financial institution can also provide a forwarding address to forward bills to the military customers. The forwarding address could be a PO box, with a service that can open and scan mail. The service can permit the military customers and the person with the POA (or the informed person) to view forwarded mail online. The service can also incorporate bills into an eBill system for viewing and (automatic or manual) payment.

The financial institution can also provide services that can help the military customer with authentication issues while deployed overseas. For example, because the financial institution knows that military customer is deployed overseas, the financial institution can automatically authenticate the military customer during credit card transactions made overseas by the military customer. The authentication can occur in lieu of the military customer formally notifying the financial institution that the military customer is travelling to an overseas location. This can be achieved because the financial institution already knows that the military customer is deployed overseas.

The financial institution can also help the military customer with other authentication issues that may occur overseas. For example, when the military customer cannot access the Internet overseas because of firewall or other issues, the financial institution can permit authentication via biometric means, such as a facial or retinal scan. In an example implementation, the facial or retinal scan can be obtained via a smartphone of the military customer and sent to the financial institution via a telephone connection.

The financial institution can also provide a financial boot camp service for military customers. The financial boot camp service can train the military customers, using highly structured drills, to provide financial education and to develop healthy financial habits. The financial boot camp service can build on the structure of physical boot camp that is familiar and generally effective for the military customers.

Using the systems and methods the financial institution can provide value added services to help the military customer and his/her family during service transition points. Example transition points can be 1) when a pre-deployed military person first becomes a customer of the financial institution, 2) when the deployment status of an existing military customer changes from pre-deployed to deployed and 3) when the deployment status of an existing military customer changes from deployed to post-deployed. Other transition points are possible, for example when status of the military customer goes on leave and when the military customer returns from leave.

The financial institution can provide different value added services for each transition point. For example, when a pre-deployed military customer first becomes a customer of the financial institution, the financial institution can give the military customer a 30-day overdraft fee waiver during an introductory period at the financial institution. When the status of the military customer changes from pre-deployed to deployed, the financial institution can extend the 30-day overdraft fee waiver for an additional period of time. When the status of the military customer changes from deployed to post-deployed, the financial institution can provide one or more rewards to the military customer, such as a monetary gift (for example $50) for completing deployment or a gift card for a store or a service, for example Starbucks or Netflix, respectively, that the military customer is known to like.

Other examples are possible. Each of the value added services and rewards provided by the financial institution can be a way to create good will between the military customer and the financial institution.

Other services that can be provided can include educational and training services such as helping the military customer transition to a new occupation after deployment. For example, if the military customer operated a tank during deployment, training services can be provided to teach the military customer to drive a truck as a career. Similarly, if the military customer was in the signal corps during deployment, training services can be provided in computing programming or advanced electronics.

Additional services can be provided to help the military customer with financial or other problems after deployment. One example service can be CaringBridge, which permits people facing various medical conditions to communicate via a website. In an example implementation, if the military customer is injured during deployment, as a way to help the military customer, the financial institution can automatically set up a CaringBridge site for the military customer and his/her family.

In addition, gamification techniques can be used to encourage the military customer to engage in educational activities. For example, rewards can be offered for attending a training seminar or for watching a video related to educational opportunities. Gamification and rewards can also be offered to encourage the military customer to perform other activities, such as assigning a power of attorney, creating an advanced directive, and setting up an emergency savings account.

The systems and methods discussed herein are directed to a computing technology that can minimize financial risk to a financial institution based on a deployment status of a military customer of the financial institution. The financial institution can automatically determine a deployment status of the military customer. When the deployment status is determined, the financial institution can automatically display a user interface to the military customer that is specific to the deployment status.

Displaying a specific user interface based on deployment status improves an efficiency of an electronic computing device at the financial institution, because fewer interactions with the military customer, and hence fewer computer cycles, are needed to determine how to process data associated with a particular account for a military customer. As a result, less communication, and fewer additional computer resources, are need to implement actions, such as an advanced directive, that can minimize the financial risk during deployment.

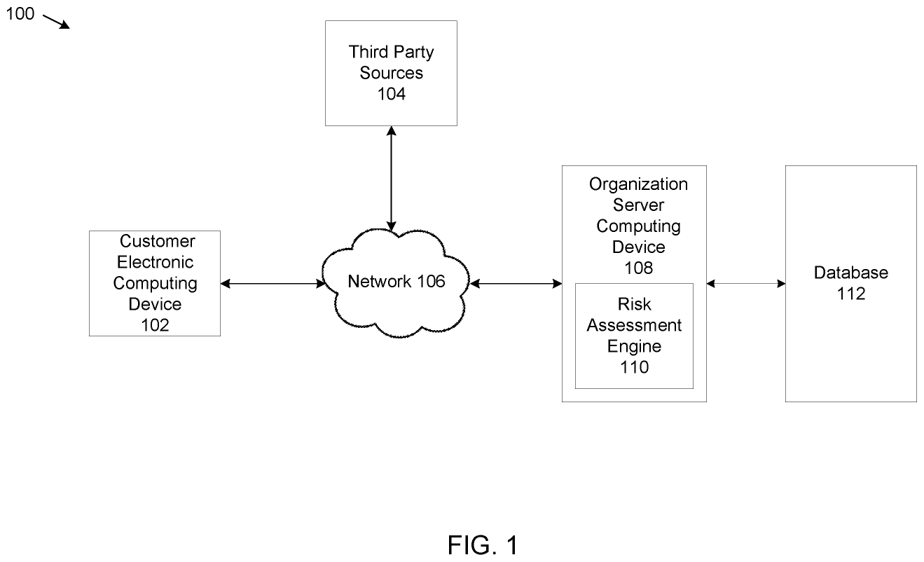

FIG. 1 shows an example system 100 that can support mitigating risk during deployment of military customers. System 100 includes a customer electronic computing device 102, third party sources 104, a network 106, an organization server computing device 108 and a database 112. Organization server computing device 108 includes a risk assessment engine 110. More, fewer or different components are possible.

The example customer electronic computing device 102 is an electronic computing device of a military customer of a financial institution, such as a bank. The military customer is a person who serves in the armed forces of the United States, such as Army, Navy, Marine Corps, Air Force, Coast Guard, etc. The military customer can have one of three deployment statuses—pre-deployed, deployed and post-deployed. The electronic computing device can be one or more of a desktop computer, a laptop computer, or a mobile computing device, such as a tablet computer or a smartphone. Other electronic computing devices are possible.

The example third party sources 104 are electronic computing devices, typically server computing devices, of third party organizations that can provide information regarding the military customer to organization server computing device 108. Example third party sources 104 can be the DMDC and other government military organizations, organizations from which the military customer has obtained a mortgage, third party organizations at which the military customer has investment, credit bureaus, employers of family members of the military customer, and state and local government organizations. Other third party sources are possible.

The example network 106 is a computer network and can be any type of wireless network, wired network and cellular network, including the Internet. Customer electronic computing device 102 can communicate with organization server computing device 108 using network 106.

The example organization server computing device 108 is a server computing device of the financial institution. The military customer can have one or more financial accounts at the financial institution, including a mortgage.

The example risk assessment engine 110 monitors the deployment status of military personnel who are customers of the financial institution. Risk assessment engine 110 also determines a financial risk for a military customer based on the deployment status and a financial status of the military customer. Risk assessment engine 110 also determines strategies for mitigating financial risk for the military customer and for providing incentives for reducing the financial risk. Risk assessment engine 110 is described in more detail later herein.

The example database 112 is a database associated with the organization of organization server computing device 108. Database 112 can store personal, financial, and deployment information for military customers. The personal, financial, and deployment information can originate from one or more of the military customer at customer electronic computing device 102, third party sources 104, meetings between the military customer and an employee of the financial institution and from risk assessment engine 110. Database 112 can be distributed over a plurality of databases. Organization server computing device 108 can be programmed to query (e.g. using Structured Query Language, SQL) database 112 to obtain the military customer information.

An example schema including, but not limited to, military customer information stored in database 112 is shown below. More, fewer, or different fields are possible.
Customer Name—the name of the military customer;
Customer ID at financial institution—a set of letters, numbers, or other symbol that uniquely identifies the military customer at a financial institution at which the military customer has at least one financial account;
Customer military ID—a set of letters, numbers, or other symbol that uniquely identifies the military customer in the armed forces;
Customer deployment status—a phrase indicating a deployment status of the military customer, typically one of pre-deployed, deployed or post-deployed;
Date of last change in deployment status—a day, month and year of a most recent change in the deployment status of the military customer;
Customer deployment location—a geographical location at which the military customer is deployed;
Customer financial risk tier—a phrase indicating a financial risk tier of the military customer, typically low risk, moderate risk or high risk;
Pointer to customer financial accounts—a pointer to an area of memory providing information regarding financial accounts at the financial institution for the military family;
Pointer to customer family information—a pointer to an area of memory providing information regarding the customer family, including names, date of births, employers, current salary, etc.
Designated Power of Attorney—a name of a person designated as a power of attorney for the military customer; field is null when a power of attorney has not been designated;
Advanced Directive status—a status field indicating yes or no as to whether the military customer has an advanced directive;
Pointer to Advanced Directive data—a pointer to an area of memory listing details of the advanced directive;

The above schema permits the database to be queried for data such data as current deployment status of the military customer and information regarding a power of attorney and an advanced directive for the military customer.

As an example, the following messaging format can be used between the organization server computing device 108 and the database 112 to obtain the current deployment status of a military customer.

| | |
|---|---|
| Customer ID | Customer Deployment Status |

As an example, the database 114 can use the following messaging format in responding to such a request. In this example, a customer deployment status of “pre-deployed” is returned in response to the request.

| | |
|---|---|
| Customer ID | Customer Deployment Status |

Pre-deployed

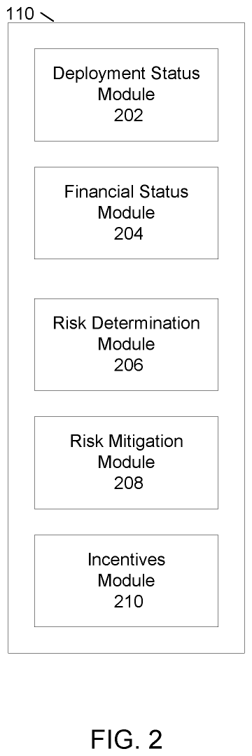

FIG. 2 shows example modules of risk assessment engine 110. Risk assessment engine 110 includes a deployment status module 202, a financial status module 204, a risk determination module 206, a risk mitigation module 208 and an incentives module 210. More, fewer or different modules are possible.

The example deployment status module 202 obtains a current deployment status of a military customer of the financial institution and also determines when a change in deployment status occurs. In an example implementation, deployment status module can use an API of the DMDC to determine the deployment status of the military customer. Because the DMDC only provides a current deployment status, deployment status module 202 can periodically poll the DMDC via the API to determine any change in deployment status.

The example financial status module 204 obtains information regarding a financial status of the military customer. Example information that can be obtained can include items such as employment history, current salary, investments, bank account balances and mortgage and other debt for the military customer. Similar information can be obtained for the spouse and other family members of the military customer. The information can be obtained directly from the customer and family members of the customer, from financial account information for the customer maintained by the financial institution and from one or more third party sources 104. For example a third party source can be a credit monitoring service or a mortgage company from which the military customer obtained a mortgage.

The example risk determination module 206 determines a financial risk for the financial institution based on the deployment status and financial status of the military customer. Risk determination module 206 can also determine a financial risk tier for the military customer. The financial risk tier can indicate a likelihood that the military customer may have trouble making timely payments on a mortgage or other loans, or may be a candidate for financial education or other programs offered by the financial institution or may need direct financial counseling with a financial representative of the financial institution. Alternatively, the financial risk tier can also indicate that the military customer is a low financial risk for the financial institution and may need minimal financial assistance from the financial institution.

In one example implementation, there can be three financial risk tiers—a low risk tier, a moderate risk tier and a high risk tier. The low risk tier can indicate that the military customer is a low risk and does not require periodic monitoring. The moderate risk tier can indicate that the military customer has one or more factors, for example occasional late payment on a mortgage or other bills that can require periodic monitoring. The high risk tier can indicate that the military customer has a low credit score or has consistently demonstrated behavior such as persistent late payments or unresponsiveness to inquiries that demonstrates a high risk to the financial institution and more frequent monitoring. Other risk tiers are possible. In addition, in some implementations, a financial risk score, for example a number from 1 to 100, can be calculated in lieu of or in addition to the financial risk tier.

The example risk mitigation module 208 can determine one or more strategies for minimizing financial risk for the military customer. Example strategies can include educational programs, personal financial counseling, a use of gamification, and recommendations for other counseling, for example psychological, sociological, or medical counseling. On a post-deployment basis, the risk mitigation module 208 can also introduce training programs that can help the military customer train for a new career after deployment. Other strategies are possible to mitigate risk for the military customer.

The example incentives module 210 can suggest one or more incentives to the military customer that may motivate the military customer to become more knowledgeable or responsible regarding personal finance and other issues, such as military deployment. Example incentives can include rewards for taking certain actions, such as starting or regularly contributing to a savings account or making regular payments on a mortgage. Example rewards can include waiving draft overdraft fees, discounts and monetary rewards.

The incentives module 210 can implement a plurality of techniques to inform and motivate the military customer. One technique can be gamification, whereby the military customer can be encouraged to play a game in which personal finance and other issues can be introduced. For example, the game can permit the military customer to select multiple paths and to see results for each selection. One path can be to create a power of attorney and advanced directive before deployment. The game can provide example events during deployment, such as a need to pay a bill or a need to make a repair on a roof or a home appliance. The game can show the military customer how the power of attorney and advanced directive can permit a family member or other designated person to pay the bill or to authorize the repair. The game can also show the military customer problems that could result if these events were to occur without having a power of attorney or advanced directive.

The incentives module 210 can also provide rewards to the military customer as an inducement to the military customer to view educational videos or participate in a game. For example, in some implementations the incentives module 210 can provide reward points to the military customer when the military customer completes a viewing of an educational video or participates in a game.

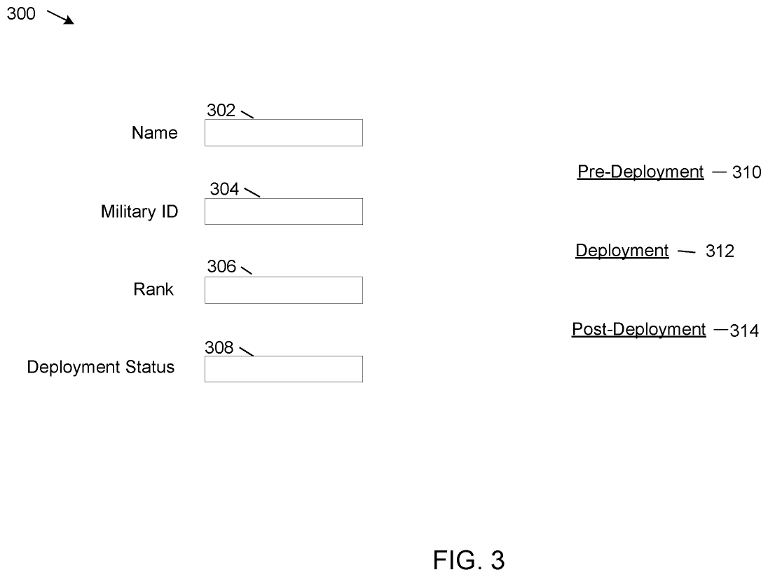

FIG. 3 shows an example graphical user interface (GUI) 300 for system 100. GUI 300 can be rendered when a military customer logs into organization server computing device 108.

GUI 300 includes examples edit boxes for name 302, military ID 304, rank 306 and deployment status 308. These edit boxes display the name, military ID, rank and deployment status, respectively, of the military customer. The information displayed in these edit boxes can be obtained from storage at organization server computing device 108 or database 112. Typically, these edit boxes are read-only. More, fewer, or different edit boxes can be shown. In some implementations, other components, such as list boxes, may be used instead of edit boxes.

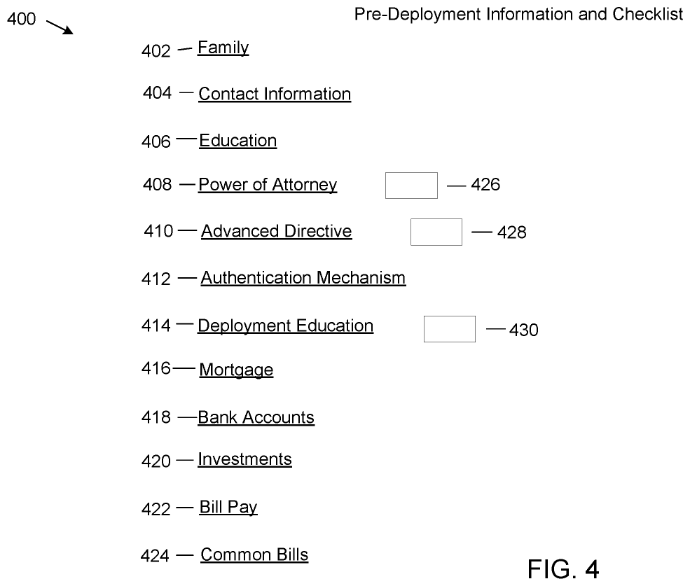

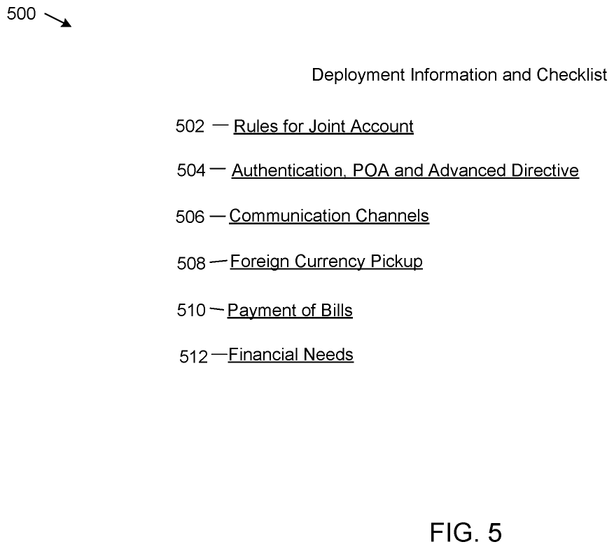

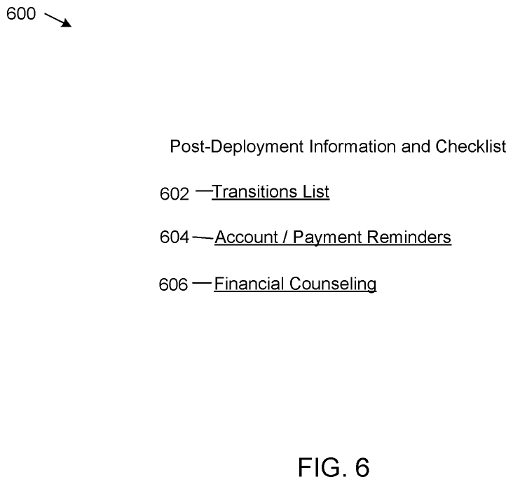

GUI 300 also includes links for pre-deployment 310, deployment 312 and post-deployment 314. When the link for pre-deployment 310 is selected, a pre-deployment information and checklist user interface is displayed, as described later herein with regard to FIG. 4. When the link for deployment 312 is selected, a deployment information and checklist user interface is displayed, as described later herein with regard to FIG. 5. When the link for post-deployment 314 is selected, a post-deployment information and checklist user interface is displayed, as described later herein with regard to FIG. 6.

FIG. 4 shows an example graphical user interface for a pre-deployment information and checklist user interface 400. The example pre-deployment information and checklist user interface 400 is rendered when the military customer selects the pre-deployment 310 link of FIG. 3. The pre-deployment information and checklist user interface 400 permits the military customer to obtain information and checklist reminders for a plurality of items related to pre-deployment.

The pre-deployment information and checklist user interface 400 includes links for family 402, contact information 404, education 406, power of attorney 408, advanced directive 410, authentication mechanism 412, deployment education 414, mortgage 416, bank accounts 418, investments 420, bill pay 420 and common bills 424. More, fewer or different link items are possible.

When the example family 402 link is selected, information regarding the family of the military customer is displayed. The information can include the names, ages, and employers of the military customer and his/her family. Other information can be displayed and the military customer can make updates to the information.

The example contact information 404 link can be used to provide identification information for a person designated by the military customer to be called in an emergency.

The example education 406 link can be used to provide education information for the military customer, such as degrees earned and any special training the military customer may have received.

The example power of attorney 408 link can be used to permit the military customer to designate a person as a power of attorney who can sign documents and perform other activities on behalf of the military customer when the military customer is deployed. An edit box 426 can indicate, for example by a check or an x marking, that the military customer currently has a power of attorney.

The example advanced directive 410 link can be used to permit the military customer to set up an advanced directive to take effect when the military customer is deployed or incapacitated. The advanced directive can identify specific activities that the military customer wants or needs handled and can identify a specific person to handle the specific activities. An edit box 428 can indicate whether or not the military customer currently has an advanced directive. When the military customer does have an advanced directive, edit box 428 is marked, for example by a check or an x. The advanced directive 410 link can also permit the military customer to select when the advanced directive is activated. For example, the military customer can select to have the advanced directive to activate automatically upon a change in deployment status from pre-deployed to deployed.

The example authentication mechanism 412 link can be used to permit the military customer to set up a method of authentication when the customer is deployed, particularly when the military customer is deployed overseas. Normal authentication mechanisms, for example user ID and password may not work from overseas because of firewall and other security issues. An alternative authentication mechanism can comprise obtaining a voice print, a facial scan or a retinal scan of the military customer, saving the voice print, facial scan or retinal scan and comparing with a voice print, facial scan or retinal scan during a login attempt during deployment. Other authentication mechanisms are possible.

The example deployment education 414 link can be used to display educational events the military customer has attended regarding deployment. The educational events can include such things as lectures attended, videos viewed, briefings attended and other events. The deployment education 414 link can also be used to permit the military customer to sign up for one or more educational events regarding deployment. An edit box 430 can indicate whether the military customer has attended any deployment education events.

The example mortgage 416 link can be used to provide information regarding any home mortgages the military customer may have, such as an amount of the mortgage, a type of mortgage, a current interest rate paid on the mortgage and contact information for a holder of the mortgage.

The example bank accounts 418 link can be used to identify any bank accounts the military customer or family members of the military customer may hold at the financial institution.

The example investments 420 link can be used to identify any investments the military customer may have, either at the financial institution or elsewhere. The bill pay 420 link can be used to indicate which bills, if any, are set up to be paid via a bill pay mechanism on a website of the financial institution. The bill pay 420 link can also be used to set the customer up for bill pay, when bill pay is not currently being used.

The example common bills 424 link can be used to identify bills that need to be paid by the military customer and his/her family and to set up a method of paying these bills when the military customer is deployed. For example, the military customer may designate a person in the advanced directive who can pay the bills when the military customer is deployed. This person can be the person with the POA or the person can be an informed person who does not have a POA, as discussed earlier herein.

FIG. 5 shows an example graphical user interface for a deployment information and checklist user interface 500. The example deployment information and checklist user interface 500 is rendered when the military customer selects the deployment 312 link of FIG. 3. The deployment information and checklist user interface 500 permits the military customer to obtain information and checklist reminders for a plurality of items related to deployment.

The pre-deployment information and checklist user interface 500 includes links for rules for joint account 502, authentication, power of attorney and advanced directive 504, communication channels 506, foreign currency pickup 508, payment of bills 510 and financial needs 512. More, fewer or different link items are possible.

The example rules for joint account 502 link can be used to specify rules during deployment for handling any joint accounts for the military customer. For example, the military customer can have a joint checking or savings account with his/her spouse. Normally, the joint account permits either party to have complete access to the joint account. But in situations where two signatures are required or for other unforeseen circumstances, the military customer can specify a rule that can waive any required joint signatures during deployment. For some financial institutions, specifying the rule may require the military customer, along with the spouse, to sign a form to implement waiving the required joint signatures during deployment. Other examples of rules for the joint account are possible.

The example authentication, POA and advanced directive 504 link can be used to set up, change or verify an authentication mechanism, a power of attorney and an advanced directive during deployment. In an example implementation, authentication, POA and advanced directive 504 link can activate a web page having the same authentication mechanism information as for authentication mechanism link 412, the same power of attorney information as power of attorney link 408 and the same advanced directive information as advanced directive link 410. Authentication, POA and advanced directive 504 link can be used to set up an authentication mechanism to be used during deployment, if such a mechanism hasn't already been set up. Authentication, POA and advanced directive 504 link can also be used to verify any authentication mechanism that may have been created via authentication mechanism link 412 or to make any updates to the authentication mechanism that may have already been created. Similarly, authentication, POA and advanced directive link can verify, create or make updates to, respectively, a power of attorney for the military customer set up via power of attorney link 408 and an advanced directive for the military customer set up via an advanced directive link 410.

The example communication channels 506 link can be used to set up one or more communication channels for the military customer for a situation where the Internet may not be available. Example communication channels can include a text-message channel or a telecommunications channel. For example, the text-message channel can include a dual-authentication mechanism where upon sending a text-message to the financial institution, the military customer can be sent one or more personalized questions, previously set up by the military customer, that the military customer, but not an imposter, would be able to answer. The telecommunications channel can comprise a standard telephone connection in which the military customer can be authenticated by one or more of a unique password or a voice print. In some implementations, the telecommunications channel can comprise a secure military telephone connection to the financial institution.

The example foreign currency pickup 508 link can be used to set up a mechanism for the military customer to obtain foreign currency during deployment. The mechanism can be implemented through the financial institution and can comprise the use of a special identifier that can be sent from a foreign location to the financial institution. The special identifier can be a unique identifier that the user can specify using the foreign currency pickup 508 link. One or more authentication questions can also be set up via the foreign currency pickup 508 link.

In an example implementation, when the military customer is in need of foreign currency during deployment, the military customer can enter a location in a foreign country where the foreign currency can be obtained. After the military customer is authenticated, for example via a photo ID, an employee at the foreign location can establish a connection with a website of the financial institution. The military customer can enter the unique identifier, and, in response to the military customer answering one or more of the authentication questions, the military customer can be authorized to receive the foreign currency. An amount of the foreign currency in U.S. dollars can be deducted from a financial account of the military customer and the military customer can receive the foreign currency. Other authentication examples are possible.

The example payment of bills 510 link can permit the military customer to specify how bills are to be paid during deployment. For example, the military customer can designate or set up an automatic bill pay during deployment, can specify a person for whom the military customer has given power of attorney or can identify an advanced directive signed by the military customer that can provide instructions as to how the bills are to be paid during deployment. Other examples are possible.

The example financial needs 512 link can permit the military customer to specify any financial needs that the military customer may have during deployment and to set up an appointment with a financial counselor to discuss how to handle the financial needs. The financial needs can include payment of bills, payment of a mortgage, child care expenses and other needs. In some implementations, the financial needs 512 link can display a checklist of common financial needs that the military customer can consider.

FIG. 6 shows an example graphical user interface for a post-deployment information and checklist user interface 600. The example post-deployment information and checklist user interface 600 is rendered when the military customer selects the post-deployment 314 link of FIG. 3. The post-deployment information and checklist user interface 600 permits the military customer to obtain information and checklist reminders for a plurality of items related to post-deployment.

The post-deployment information and checklist user interface 600 includes links for a transitions list 602, account/payment reminders 604 and financial counseling 606. More, fewer or different link items are possible.

The example transitions list 602 link can activate a webpage that can display a list of tasks that the military customer can consider implementing post-deployment. The list of tasks can include tasks that based on experience are typical tasks that are beneficial to be considered post-deployment. Example tasks can include items such as housing, job training, post-deployment benefits counseling, educational videos or lectures regarding adjusting to life post-deployment, and other items.

The example account/payment reminders 604 link can activate a webpage that can display a list of reminders regarding activating or adjusting financial accounts and bill payments for the military customer. For example, one or more financial accounts of the military customer may have been controlled by an advanced directive or deactivated during deployment. The account/payment reminders 604 link can remind the military customer of the status of the one or more financial accounts and permit the military customer to make adjustments. The account/payment reminders 604 link can also remind the military customer of bills that need to be paid during post-deployment, for example for housing that was previously paid for by the military. Reminders can also include adjusting or re-starting bill pay or deactivating or changing an advanced directive regarding payment of bills.

The example financial counseling 606 link can activate a webpage that can provide resources regarding financial counseling for the military customer. The resources can include lectures or seminars, educational videos and a list or individuals or organizations that can provide financial counseling to the military customer and his/her family. The webpage can also provide contact information for the individuals or organizations and can permit the military customer to make an appointment with one of the individuals or organizations.

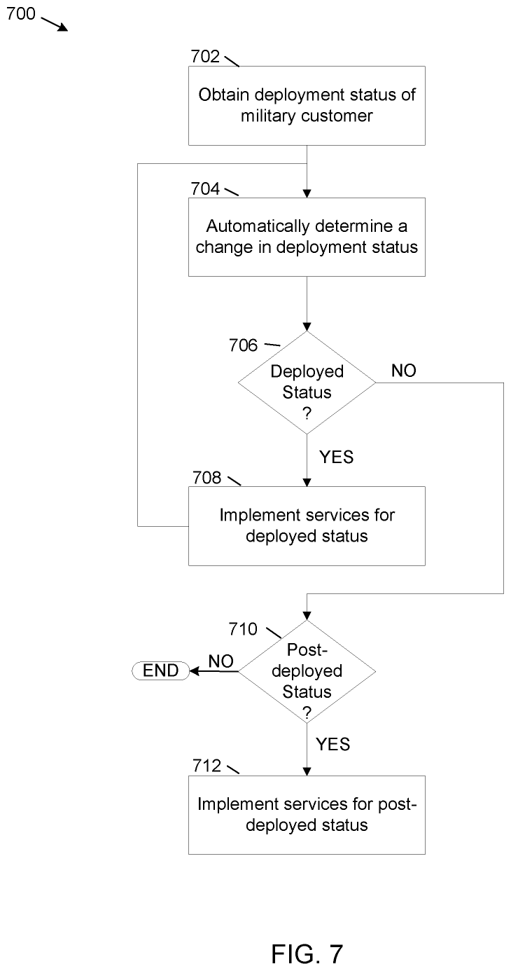

FIG. 7 shows a flowchart for an example method 700 for implementing services for a military customer of a financial institution based on a detection of a change in deployment status of the military customer.

At operation 702, a current deployment status of the military customer is obtained. For method 700, the current deployment status is obtained from the Defense Manpower Data Center (DMDC) of the United States Department of Defense. For method 700, the current deployment status can be one of pre-deployed, deployed or post-deployed.

At operation 704, a change in deployment status for the military customer is automatically determined. To detect the change in deployment status the financial institution, or a third party authorized by the military customer and the financial institution, periodically requests the current deployment status of the military customer from the DMDC. For method 700, the deployment status is obtained daily. For other implementations, different time intervals can be used. The financial institution compares the current deployment status of the military customer with the last previously obtained deployment status and determines whether there is a change in deployment status. Since the initial deployment status is typically pre-deployed, any change in deployment status would be from pre-deployed to deployed or from deployed to post-deployed.

At operation 706, a determination is made as to whether the deployment status has changed to deployed. At operation 706, when a determination is made that the deployment status has changed from pre-deployed to deployed, at operation 708, services for a deployment status are implemented for the military customer. These services, as discussed with regard to FIG. 5, can include such items as updating rules for joint accounts, checking for and implementing, if necessary, a power of attorney, an advanced directive and an authentication mechanism, implementing communication channels, foreign currency pickup, providing for payment of bills and providing communication regarding financial needs during deployment. In addition, when incentives are needed to induce the military customer to obtain a power of attorney or create an advanced directive, gamification and rewards can be used, as discussed earlier herein.

At operation 706, when a determination is made that the deployment status has not changed to deployed, at operation 710, a determination is made whether the deployment status for the military customer has changed from deployed to post-deployed.

When the deployment status is post-deployed, at operation 712, services for a post-deployment status are implemented for the military customer. These services, as discussed with regard to FIG. 6, can include such items as providing a transitions list for post-deployed status, account/payment reminders and financial counseling.

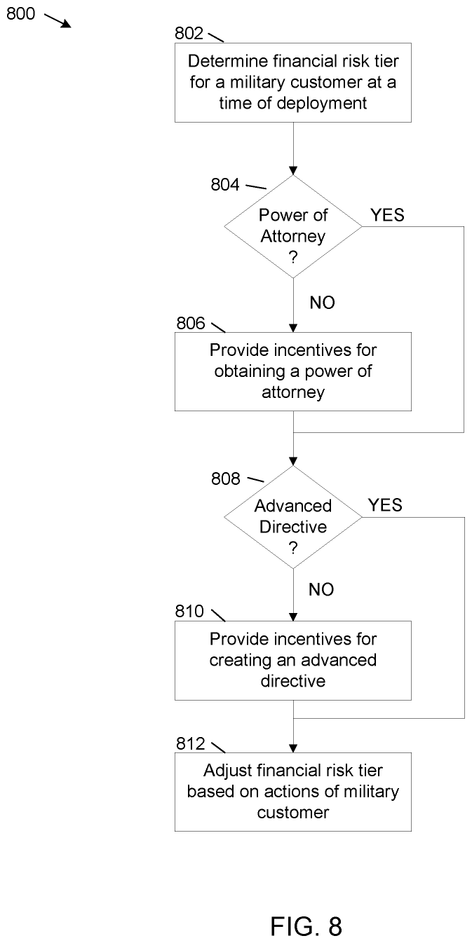

FIG. 8 shows a flowchart for an example method 800 for determining a financial risk tier for the military customer at a time of transition to deployment and for providing incentives to the military customer to move into a lower risk tier.

At operation 802, the financial institution determines a financial risk tier for the military customer. For method 800, one of three risk tiers can be determined—a low risk tier, a moderate risk tier and a high risk tier. The financial risk tier can be determined from a plurality of factors for the military customer and for the spouse and other family members of the military customer including, credit rating, financial account balances, investments, mortgage and other debt, current income and anticipated income during deployment. Other factors can also be considered, such as whether the military customer has a power of attorney and an advanced directive that can be activated during deployment.

At operation 804, a determination is made as to whether the military customer has a power of attorney. When a determination is made that the military customer does not have a power of attorney, at operation 806, incentives are provided to attempt to persuade the military customer to obtain the power of attorney. The incentives can include rewards, such as a gift, for obtaining a power of attorney. The incentives can also take the form of gamification, whereby the military customer can be persuaded to play an interactive or other game that can show the benefits of obtaining a power of attorney and that can attempt to convince the military customer to obtain the power of attorney. Other incentives are possible.

At operation 808, a determination is made as to whether the military customer has an advanced directive. When a determination is made that the military customer does not have an advanced directive, at operation 810, incentives are provided to attempt to persuade the military customer to obtain the advanced directive. The incentives can include rewards and gamification, similar to that provided for the power of attorney at operation 806.

At operation 812, the financial risk tier for the military customer is adjusted based on whether the customer has obtained one or more of the power of attorney and the advanced directive. Because having a power of attorney and an advanced directive during deployment is beneficial to the financial institution, providing more certainty that bills will be paid during deployment, the financial institution can lower the financial risk tier for the military customer when the military customer obtains one or both of the power of attorney and the advanced directive. If both are obtained, the financial risk tier is reduced more than if only one is obtained.

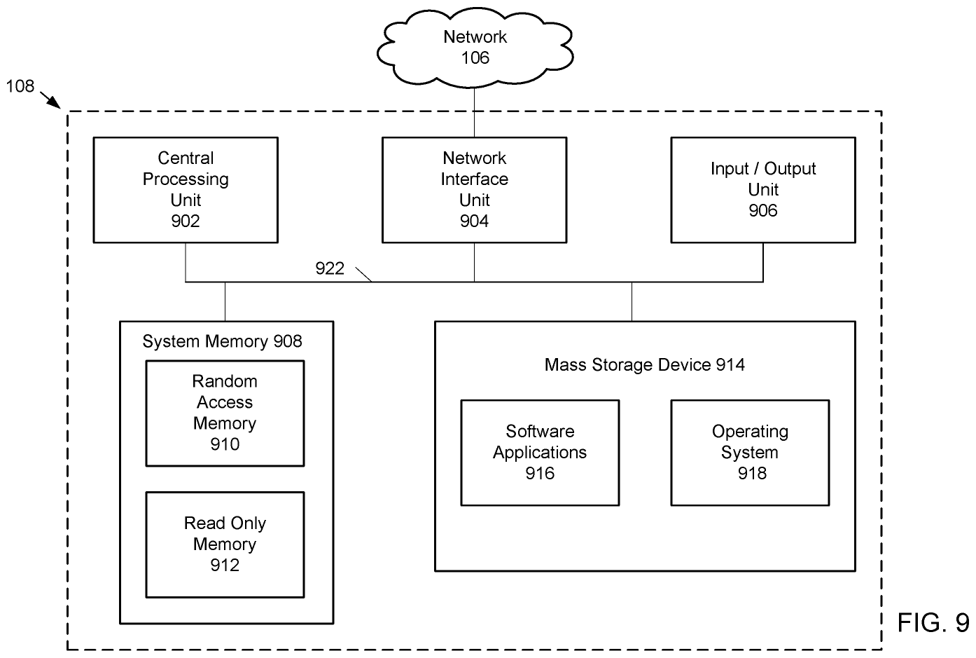

As illustrated in the example of FIG. 9, organization server computing device 108 includes at least one central processing unit (“CPU”) 902, also referred to as a processor, a system memory 908, and a system bus 922 that couples the system memory 908 to the CPU 902. The system memory 908 includes a random access memory (“RAM”) 910 and a read-only memory (“ROM”) 912. A basic input/output system that contains the basic routines that help to transfer information between elements within the organization server computing device 108, such as during startup, is stored in the ROM 912. The organization server computing device 108 further includes a mass storage device 914. The mass storage device 914 is able to store software instructions and data. Some or all of the components of the organization server computing device 108 can also be included in customer electronic computing device 102 and/or one or more computing devices associated with third party sources 104.

The mass storage device 914 is connected to the CPU 902 through a mass storage controller (not shown) connected to the system bus 922. The mass storage device 914 and its associated computer-readable data storage media provide non-volatile, non-transitory storage for the organization server computing device 108. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the organization server computing device 108.

According to various embodiments of the invention, the organization server computing device 108 may operate in a networked environment using logical connections to remote network devices through the network 106, such as a wireless network, the Internet, or another type of network. The organization server computing device 108 may connect to the network 106 through a network interface unit 904 connected to the system bus 922. It should be appreciated that the network interface unit 904 may also be utilized to connect to other types of networks and remote computing systems. The organization server computing device 108 also includes an input/output controller 906 for receiving and processing input from a number of other devices, including a touch user interface display screen, or another type of input device. Similarly, the input/output controller 906 may provide output to a touch user interface display screen or other type of output device.

As mentioned briefly above, the mass storage device 914 and the RAM 910 of the organization server computing device 108 can store software instructions and data. The software instructions include an operating system 918 suitable for controlling the operation of the organization server computing device 108. The mass storage device 914 and/or the RAM 910 also store software instructions and software applications 916, that when executed by the CPU 902, cause the organization server computing device 108 to provide the functionality of the organization server computing device 108 discussed in this document. For example, the mass storage device 914 and/or the RAM 910 can store software instructions that, when executed by the CPU 902, cause the organization server computing device 108 to display received data on the display screen of the organization server computing device 108.

Although various embodiments are described herein, those of ordinary skill in the art will understand that many modifications may be made thereto within the scope of the present disclosure. Accordingly, it is not intended that the scope of the disclosure in any way be limited by the examples provided.

1-19. (canceled)

20. An electronic computing device comprises:
a processor; and
system memory, the system memory including instructions which, when executed by the processor, cause the electronic computing device to:
access a record in a database to determine a current military deployment status of a person on active duty in the military, the record including a field indicating the deployment status; and
when the current military deployment status of the person is a pre-deployment status:
select between and implement one or more procedures to minimize a financial risk level to the person during deployment outside of a home country, the one or more procedures further serving to minimize a financial risk of the person to a financial institution when the person is on the deployment outside of the home country, the one or more procedures including to:
provide one or more incentives to encourage the person to designate an individual as a power of attorney and to create an advanced directive, at least one of the incentives comprising a monetary reward; and
modify authentication requirements to address authentication by the person during the deployment outside of the home country, including to:
capture a biometric authentication mechanism to be used during deployment outside of the home country; and
automatically accept authentication credentials through different authentication techniques during deployment outside of the home country during deployment outside of the home country;
periodically access the database to monitor the current military deployment status of the person; and
when the current military deployment status indicates the deployment outside of the home country:
designate the current military deployment status of the person as deployed outside of the country;
activate the advanced directive;
authenticate the person using the biometric authentication mechanism; and
when the biometric authentication mechanism for the person is unavailable outside of the home country, automatically authenticate the person without the biometric authentication mechanism.
